(19) United States
(12) Patent Application Publication
(10) Pub. No.: US 2013/0226590 A1
(43) Pub. Date: Aug. 29, 2013

(54) VOICE INPUT APPARATUS AND METHOD

(71) Applicant: Pantech Co., Ltd., (US)

(72) Inventor: Hyun-Sook LEE, Seoul (KR)

(73) Assignee: Pantech Co., Ltd., Seoul (KR)

(21) Appl. No.: 13/718,468

(22) Filed: Dec. 18, 2012

(30) Foreign Application Priority Data
Feb. 29, 2012 (JP) 10-2012-0021475

(51) Int. Cl. G10L 19/00

(52) U.S. Cl. CPC G10L 19/00
USPC 704/275

(57) ABSTRACT

Provided is a voice input method and apparatus that may select and drive an execution screen of an application executing a screen that is requested to be executed instead of executing a default screen if executing the application. If executing an application, a user may further conveniently and quickly execute the user's selected function and display an execution screen by decreasing a plurality of touch input operations.

### CROSS-REFERENCE TO RELATED APPLICATION

This application claims priority from and the benefit of Korean Patent Application No. 10-2012-0021475, filed on Feb. 29, 2012, which is hereby incorporated by reference for all purposes as if fully set forth herein.

### BACKGROUND

1. Field

The following description relate to a voice input apparatus and method for directly executing an application.

2. Discussion of the Background

FIG. 1 is a block diagram of a system of a communication terminal according to the related art.

A communication terminal 100 may execute an application in response to a touch input. For example, if a touch input signal is received, a touch event 110 may be recognized and be processed. If the touch event 110 occurs, a touch event dispatcher 121 of a window manager service 120 may transfer the touch event 110 to an application 130 that is positioned in a touch area of the touch event 110. The application 130 may execute a function corresponding to touched coordinates of the touch event 110.

FIG. 2 illustrates a method for executing an application in a communication terminal according to the related art.

In screen 210, a communication terminal displays icons of application App 1, application App 2, . . . , and application App 9. A communication terminal may execute an application in response to a touch input received on the screen 210 of the terminal, for example on application App 5. In screen 220, the application App 5 may be executed and a default execution screen may be displayed. The application App 5 may execute a corresponding function in response to a user input on the default execution screen.

FIG. 3 illustrates a method for executing a web browser in a communication terminal according to the related art.

In screen 310, the communication terminal displays icons of multiple applications and a user may select an icon to execute an application, for example a web browser. The user may select the web browser to access a designated site, for example the portal site Naver®. The web browser may attempt to access to a default website, such as, Google® in response to the selection of the icon as illustrated in screen 320. The user may suspend or terminate the web browser's attempt to access the default website Google as illustrated in screen 330. The user may then access the designated site Naver® in screen 350 by inputting a web address of the designated site Naver® or by using a ‘favorites’ list stored in the web browser application.

After executing a default screen, the application may need to go through a plurality of operations in order to access the user's designated screen. In other words, if the user executes the application in the communication terminal using a touch, a default screen of the application may be executed and the user may access the designated screen by performing a plurality of touches and inputs.

### SUMMARY

Exemplary embodiments of the present invention provide a voice input apparatus to receive voice input.

Exemplary embodiments of present invention also provide a method for directly executing an application according to a touch input and a voice input.

Additional features of the invention will be set forth in the description which follows, and in part will be apparent from the description, or may be learned by practice of the invention.

An exemplary embodiment of the present invention discloses a method for directly executing a function of an application in a terminal, the method including: selecting an application to execute; receiving a sound input; analyzing the sound input to identify a voice input; determining an entry reason from the voice input; determining if the entry reason is a valid entry reason; and if the entry reason is the valid entry reason, directly executing a function of the application corresponding to the entry reason and displaying the execution thereof.

An exemplary embodiment of the present invention also discloses a voice input apparatus, including: a display unit configured to display an icon of an application; an input interface configured to receive a selection event on the icon; a voice input unit configured to receive sound data, to extract voice data from the sound data, and to determine if the voice data is an entry reason; and an execution manager configured to execute the application according to a touch-up event and the voice data if the voice data is the entry reason.

An exemplary embodiment of the present invention also discloses a method for executing an application in a terminal, including: detecting a touch-down event on an icon of an application; determining if sound data is received; if sound data is received, determining if the sound data is a voice command; determining if the voice command is an entry reason for the application; and if the voice command is an entry reason executing the application and displaying an entry reason execution screen according to the voice command.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a system of a communication terminal according to the related art.

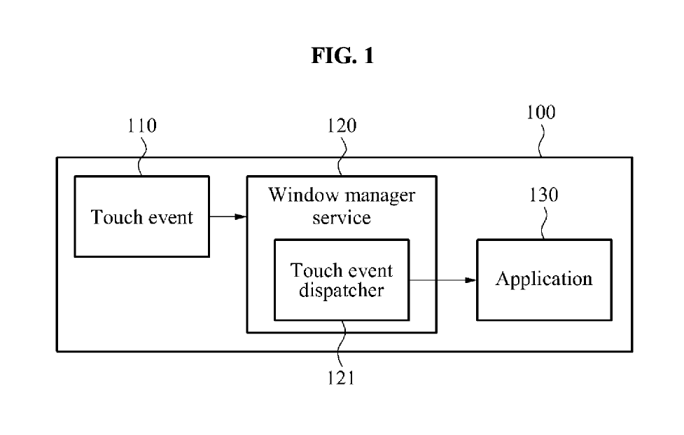

FIG. 2 illustrates a method for executing an application in a communication terminal according to the related art.

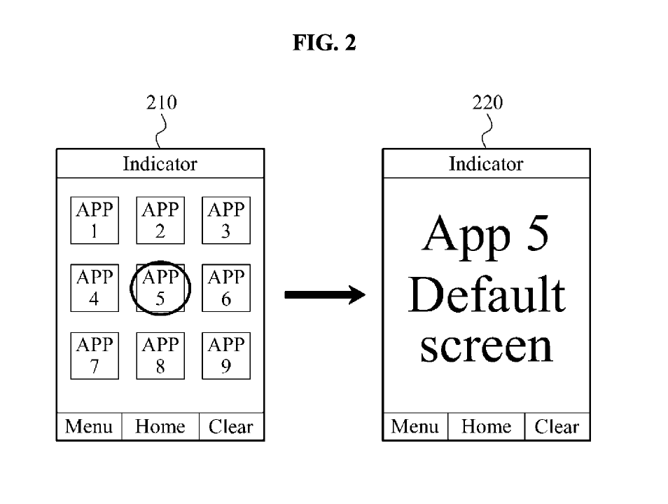

FIG. 3 illustrates a method for executing a web browser in a communication terminal according to the related art.

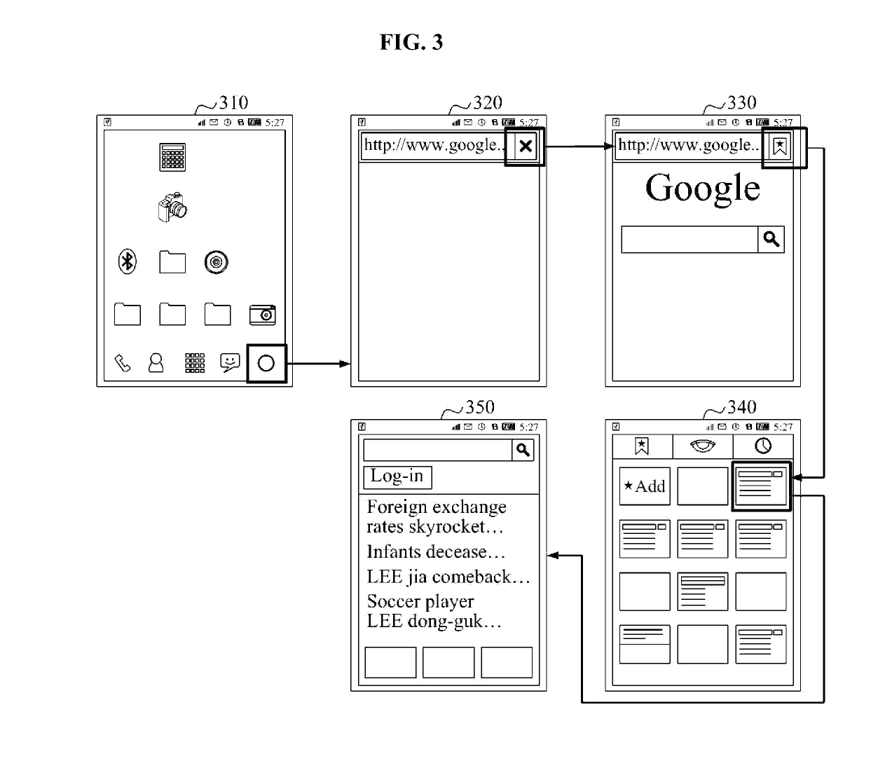

FIG. 4 is a block diagram of an interface apparatus according to an exemplary embodiment of the present invention.

FIG. 5 is a block diagram of an interface apparatus according to an exemplary embodiment of the present invention.

FIG. 6 is a flowchart of a method for selecting and driving an execution screen of an application according to an exemplary embodiment of the present invention.

FIG. 7 is a flowchart of a method for selecting and driving an execution screen of an application according to an exemplary embodiment of the present invention.

FIG. 8 illustrates displaying an execution screen selected and driven by the method of FIG. 7.

FIG. 9 is a flowchart of a method for selecting and driving an execution screen of an application according to an exemplary embodiment of the present invention.

FIG. 10 illustrates displaying an execution screen selected and driven by the method of FIG. 9.

FIG. 11 is a flowchart of a method for selecting and driving an execution screen of a web browser according to an exemplary embodiment of the present invention.

FIG. 12 is a flowchart of a method for selecting and driving an execution screen of a broadcasting output application according to an exemplary embodiment of the present invention.

FIG. 13 is a flowchart of a method for selecting and driving execution of a music playback application according to an exemplary embodiment of the present invention.

FIG. 14 is a flowchart of a method for selecting and driving execution of an electronic dictionary browser according to an exemplary embodiment of the present invention.

FIG. 15 is a flowchart of a method for selecting and driving execution of a dialer application according to an exemplary embodiment of the present invention.

FIG. 16 is a flowchart of a method for selecting and driving execution of a subway line map application according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element is referred to as being “directly on” or “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Although features may be shown as separate, such features may be implanted together or individually. Further, although features may be illustrated in association with an exemplary embodiment, features for one or more exemplary embodiments may be combinable with features from one or more other exemplary embodiments.

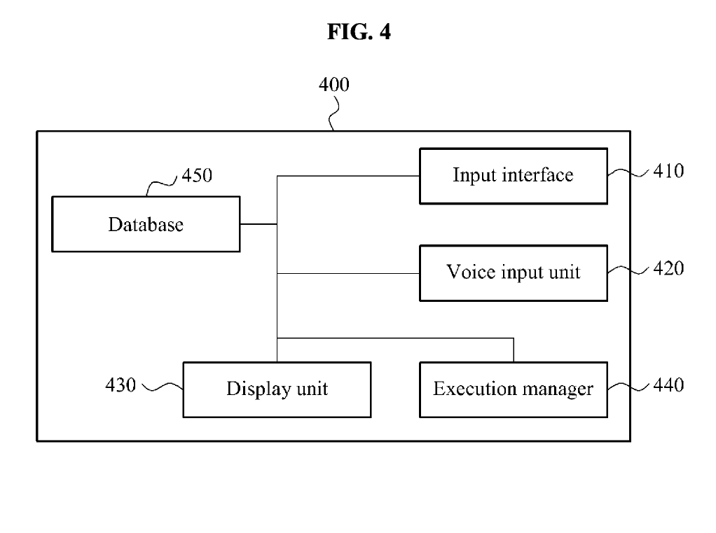

FIG. 4 is a block diagram of an interface apparatus according to an exemplary embodiment of the present invention.

Referring to FIG. 4, the interface apparatus 400 may include an input interface 410, a voice input unit 420, a display unit 430, an execution manager 440, and a database 450. The database 450 may store applications and the interface apparatus may determine if received sound data includes instructions to execute an application.

The display unit 430 may be configured to display an icon corresponding to an application on a screen and may be configured to activate the voice input unit 420 in response to a selection of the icon. The display unit 430 may receive data via the voice input unit 420 while selection of the icon is maintained, e.g., touch-down event, a long-click operation, etc.

If a selection of the icon is detected, the display unit 430 may display the input interface 410 on at least a part of the screen. The display unit 430 may receive data via the input interface 410 if a touch point moves from the icon to an area where the input interface is displayed.

The execution manager 440 may be configured to execute the application associated with the icon in response to release of the touch, e.g., a touch-up event. The execution manager 440 may execute the application by using the input data inputted via the input interface 410. The input interface 410 may include an input device, such as, a touch input, a mouse, and the like.

If the data is voice data, the input interface 410 may be configured to transfer the voice data to the voice input unit 420. The voice input unit 420 may be configured to detect a command from the voice data. The voice input unit 420 may be configured to extract analyzable data from the voice data and may transfer the extracted analyzable data to the execution manager 440 as a command.

The execution manager 440 may be configured to search the database 450 to match a command and an application. If a command does not correspond to an entry reason or reason value, a controller (not shown) may execute the application using a reference default command. The execution manager 440 may be configured to display a default screen of the application if the command does not correspond to an entry reason.

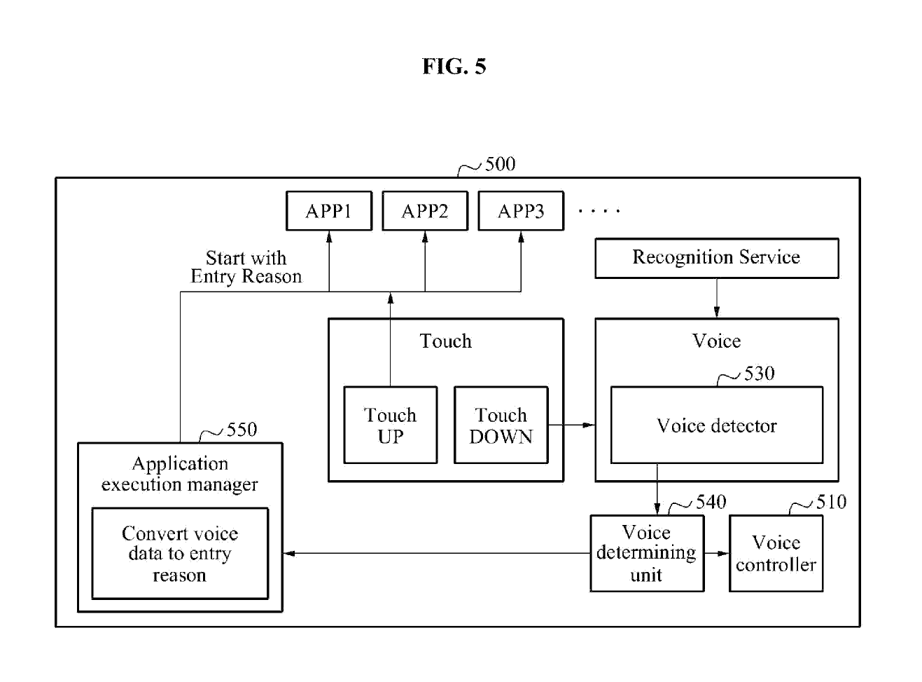

FIG. 5 is a block diagram of an interface apparatus according to an exemplary embodiment of the present invention.

Referring to FIG. 5, the interface apparatus 500 may include a voice controller 510, a voice detector 530, a voice determining unit 540, and an application execution manager 550. The voice controller 510, the voice detector 530, and the voice determining unit 540 may be components of the voice input unit 420 of FIG. 4 but are not limited thereto.

The voice controller 510 may be configured to provide an interface to control an operation of the voice detector 530. The voice controller 510 may be configured to control a voice input, a voice amplification, an end of an input, and the like of the voice detector 530 through a recognition service.

If the voice controller 510 activates the voice detector 530, the voice detector 530 may receive sound data. The voice controller 510 may activate voice detector 530 in response to a touch event or a selection event, e.g., a touch-down event, a touch-up event, a long-click, etc. The sound data may include voice data. The voice controller 510 may be configured to transfer the received sound data to the voice determining unit 540. The voice detector 530 may be configured to filter the sound data and may transfer an audio signal with a frequency within a voice frequency band to the voice determining unit 540.

The voice determining unit 540 may be configured to select and sample valid voice data from the transferred audio signal received from the voice detector 530, and may convert the sampled valid voice data to analyzable voice data, i.e., voice data that is analyzable in a terminal. The voice detector 530 may transfer analyzable voice data to the voice determining unit 540.

The voice determining unit 540 may be configured to perform syntax analysis of the analyzable voice data from the voice detector 530 and may transfer data including a right word to the application execution manager 550.

The application execution manager 550 may be configured to add data received from the voice determining unit 540 as an entry reason for application execution. An entry reason may be a command of the application to be executed. The entry reason may be determined by a user or established by the application. The application execution manager 550 may determine an operation to be executed according to a received reason for entering the application (i.e., an entry reason). For example, the application execution manager 550 may determine an execution screen to be displayed if an entry reason for application execution is received. If a touch-up event is detected an application may be executed according to default rules.

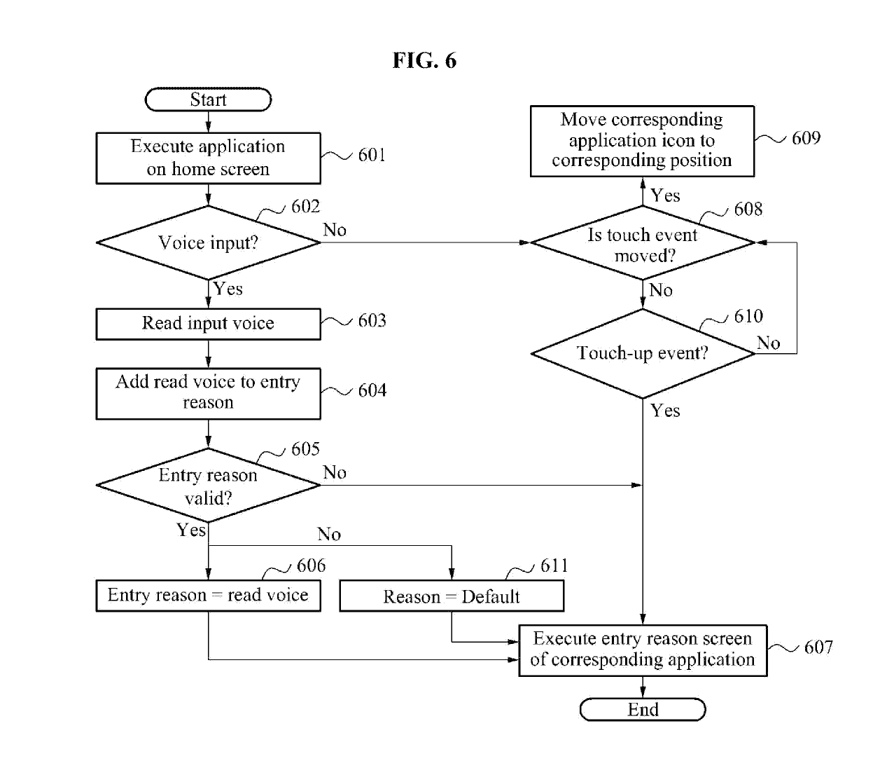

FIG. 6 is a flowchart of a method for selecting and driving an execution screen of an application according to an exemplary embodiment of the present invention.

In operation 601, a communication terminal may execute an application on a home screen. In operation 602, communication terminal may determine whether voice input is received. If voice input is received, in operation 603, the communication terminal may read the voice input. The reading may be an analysis to determine if the voice input includes an entry reason.

In operation 604, the communication terminal may add or store the read voice with an entry reason for application execution. The read voice may be stored or added to a database or table for application execution. In operation 605, the communication terminal may determine whether the entry reason is a valid entry reason for the application. The application may determine if the entry reason is a valid entry reason for the application through a series of comparisons between the entry reason received in the voice input and the entry reasons for the application. If the entry reason is a valid entry reason in operation 605, in operation 606, the application may associate the analyzed voice with the valid entry reason. In operation 607, the communication terminal display an execution screen of the application according to the entry reason. If the entry reason is not a valid entry reason, in operation 611, the communication terminal will associate the entry reason with the default entry reason and proceed to operation 607 in which the communication terminal will display a default screen.

If voice input is not received in operation 602, in operation 608, the communication terminal may determine whether a touch on the screen has moved. If the touch has moved, in operation 609, the communication terminal may move the application icon to a position corresponding to the determined touch movement. If the touch has not moved, in operation 610, the communication terminal may determine whether a touch-up event corresponding to release of the touch has occurred in the application icon.

If a touch-up event has occurred, in operation 611, the communication terminal will associate the entry reason with the default entry reason and may display an entry reason screen of the application according to the entry reason and proceed to operation 607.

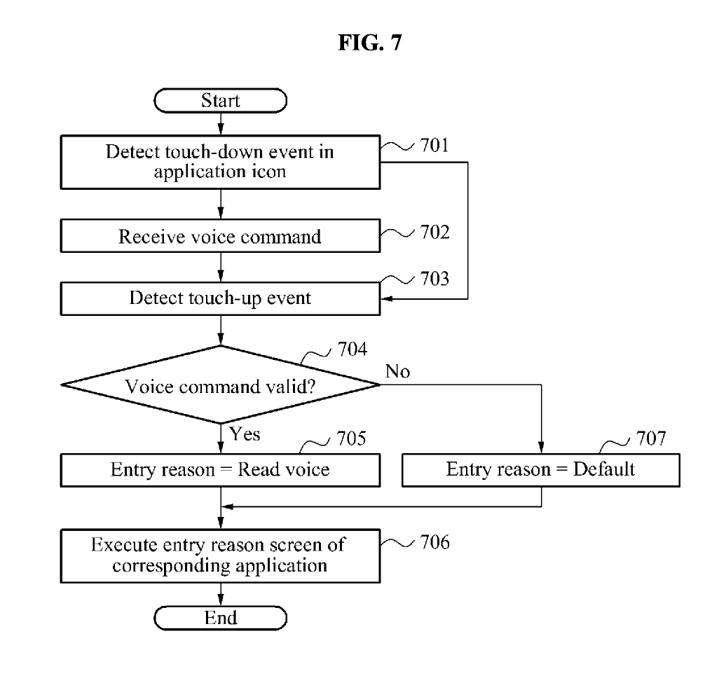

FIG. 7 is a flowchart of a method for selecting and driving an execution screen of an application according to an exemplary embodiment of the present invention.

In operation 701, a communication terminal may detect a touch-down event has occurred in an application icon. In operation 702, a voice command or voice input is received. In operation 703, a touch-up event is detected. If a voice command is not received in operation 702 before a touch-up event occurs in operation 703, operation 701 proceeds to operation 703 and such voice command may be determined to not be a valid voice command in operation 704.

In operation 704, the communication terminal may determine whether the voice command is a valid entry reason. In operation 705, if the voice command is a valid entry reason, the communication terminal may associate the voice command with the entry reason. In operation 706, the communication terminal display an execution screen of the application according to the valid entry reason. If the voice command is not a valid entry reason, in operation 707, the communication terminal will associate the entry reason with the default entry reason and proceed to operation 706 in which the communication terminal will display a default screen of the application.

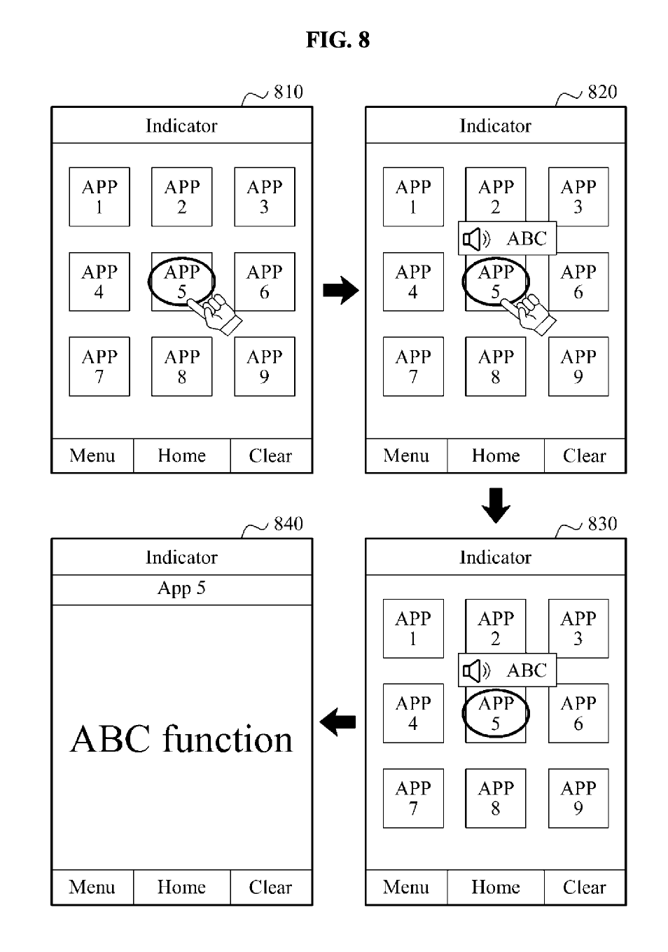

FIG. 8 illustrates displaying an execution screen selected and driven by the method of FIG. 7.

In screen 810, a communication terminal displays icons of application App 1, application App 2, . . . , and application App 9. A user may touch an application icon, e.g., application App 5, and download a corresponding application. In screen 820, a communication terminal may receive voice command while a touch is still activated, i.e., after a touch-down event is detected but before a touch-up event is detected. In screen 830, if the voice command is received and a touch-up event is detected, the communication terminal may read and/or analyze the voice command. In screen 840, the communication terminal may transfer the analyzed voice command to the application, and the application may display an execution screen of the application App 5 according to the analyzed voice command.

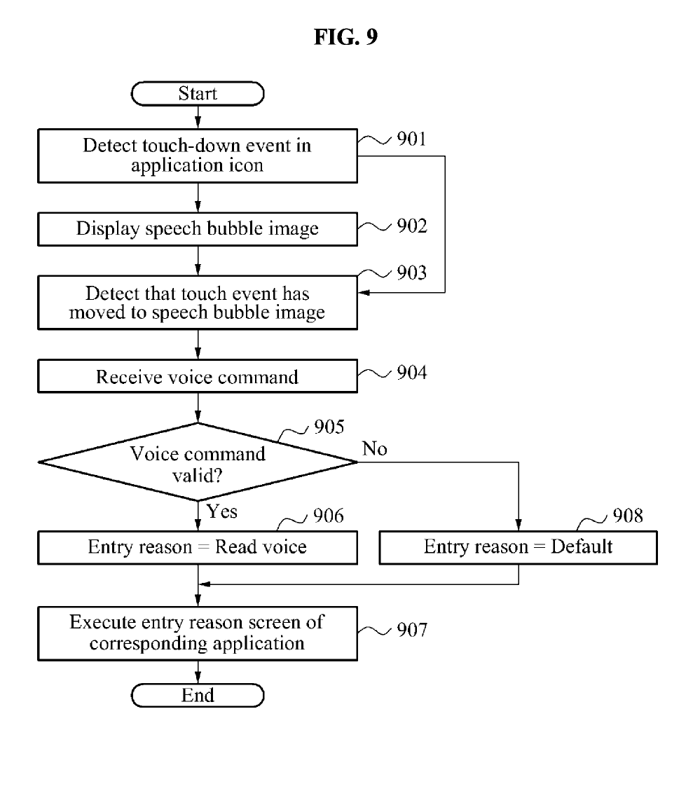

FIG. 9 is a flowchart of a method for selecting and driving an execution screen of an application according to an exemplary embodiment of the present invention.

In operation 901, a touch-down event is detected in an application icon. In operation 902, the communication terminal may display a speech bubble image. In operation 903, the communication terminal may detect that a touch event has moved to the speech bubble image. In operation 904, the communication terminal may receive a voice command. In operation 905, the communication terminal may determine if the voice command is a valid entry reason. If a voice command is not received in operation 902 before a touch-up event occurs in operation 903, operation 901 proceeds to operation 903 and such voice command may be determined to not be a valid voice command in operation 904.

If the voice command is a valid entry reason, in operation 906, the communication terminal may associate the voice command with an entry reason and proceed to operation 907 in which the communication terminal will execute a command, e.g., display an execution screen of the application, according to the entry reason. In operation 908, if the voice command is not a valid entry reason, the communication terminal will associate the entry reason with the default entry reason and proceed to may display a default screen of the corresponding application.

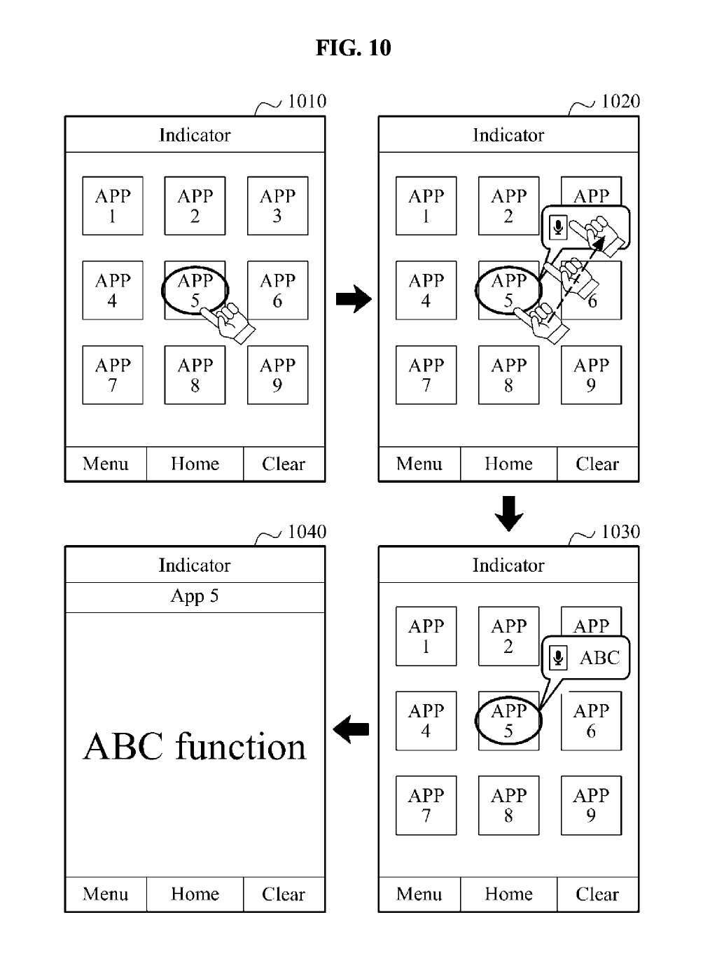

FIG. 10 illustrates displaying an execution screen selected and driven by the method of FIG. 9.

In screen 1010, a communication terminal displays icons of application App 1, application App 2, . . . , and application App 9. A user may touch an application icon, e.g., application App 5, and download a corresponding application. In screen 1020, a communication terminal may display a speech bubble image and detect that the touch event has moved to the speech bubble image. In screen 1030, the communication terminal may receive a voice command and display a voice command icon in the speech bubble image. In screen 1040, the communication terminal may display an execution screen of the application App 5 according to the valid voice command.

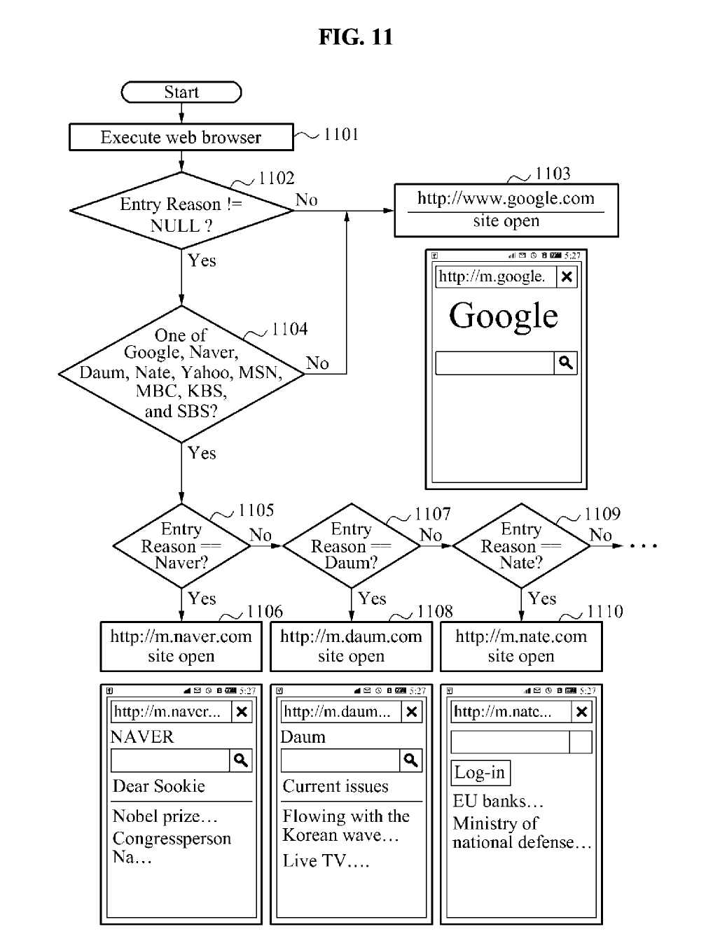

FIG. 11 is a flowchart of a method for selecting and driving an execution screen of a web browser according to an exemplary embodiment of the present invention.

In operation 1101, a communication terminal may execute a web browser. In operation 1102, the web browser may determine whether a voice command indicating a website is input into an entry reason determination. In operation 1103, if the voice command is not input, the web browser may display a default webpage, for example, the website for Google®.

If a voice command is input in operation 1102, in operation 1104, the web browser may determine whether the entry reason is one of multiple websites, for example, Google®, Naver®, Daum®, Nate®, Yahoo®, Microsoft Network® (MSN), Munhwa Broadcasting Corporation (MBC), Korean Broadcasting System (KBS), and Seoul Broadcasting System® (SBS), etc. The multiple websites may correspond to entry reasons of the web browser application. If the voice command is one of the multiple websites, the communication terminal proceeds to determine which website the voice command corresponds to. For example, in operation 1105, the web browser may determine whether Naver® is input as the entry reason. If Naver® is the entry reason, the web browser may display a Naver® site in operation 1106. If the entry reason is not Naver®, the method proceeds to operation 1107. In operation 1107, the web browser may determine whether Daum® is input as the entry reason. If Daum® is the entry reason, the web browser may display a Daum® site in operation 1108. If the entry reason is not Daum®, the method proceeds to operation 1109. Similarly, in operation 1109, the web browser may determine whether Nate is input as the entry reason. If Nate® is the entry reason, the web browser may display a Nate® site in operation 1110.

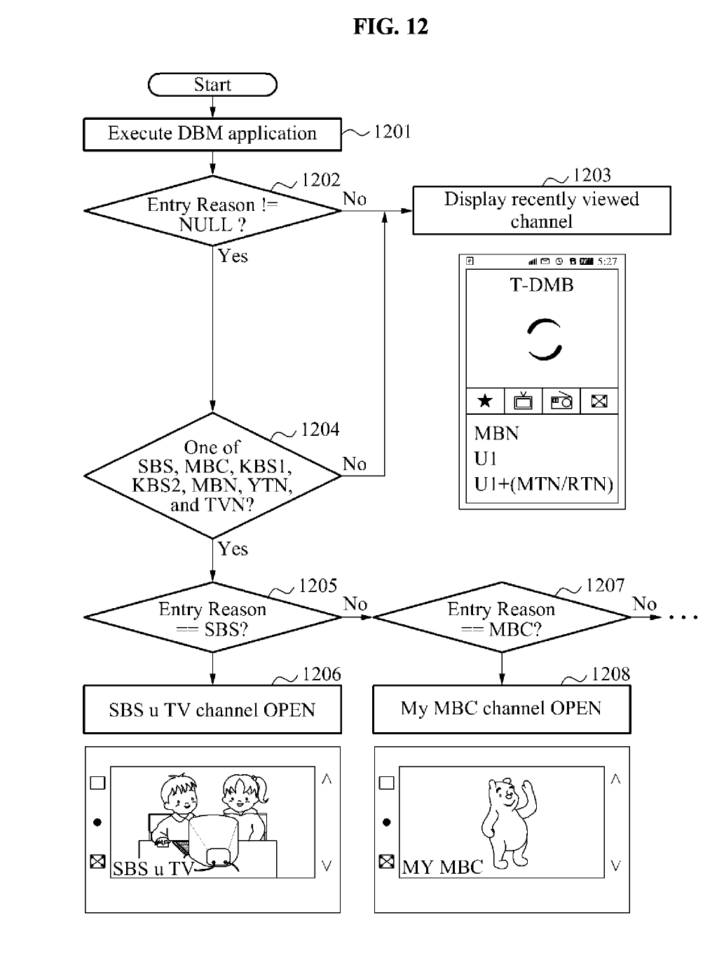

FIG. 12 is a flowchart of a method for selecting and driving an execution screen of a broadcasting output application according to an exemplary embodiment of the present invention.

In operation 1201, a communication terminal may execute a broadcasting output application, for example, a digital multimedia broadcasting (DMB) application. In operation 1202, the broadcasting output application may determine whether a voice command indicating a broadcasting channel is input into an entry reason determination. In operation 1203, if the voice command is not input, the broadcasting output application may display a default broadcasting channel, for example, a recently viewed broadcasting channel.

If a voice command is input in operation 1202, in operation 1204, the broadcasting output application may determine whether the entry reason is one of multiple broadcasting channels, for example, SBS, MBC, KBS1, KBS2, MBN, YTN, and TVN. The multiple broadcasting channels may correspond to entry reasons of the broadcasting output application. If the voice command is one of the broadcasting channels, the communication terminal proceeds to determine which broadcasting channel the voice command corresponds to. For example, in operation 1205, the broadcasting output application may determine whether the entry reason is SBS. If SBS is input, the broadcasting output application may display an SBS broadcasting channel in operation 1206. If the entry reason is not SBS, the method proceeds to operation 1207. In operation 1207, the broadcasting output application may determine whether the entry reason is MBC. If MBC is input, the broadcasting output application may display an MBC broadcasting channel in operation 1208.

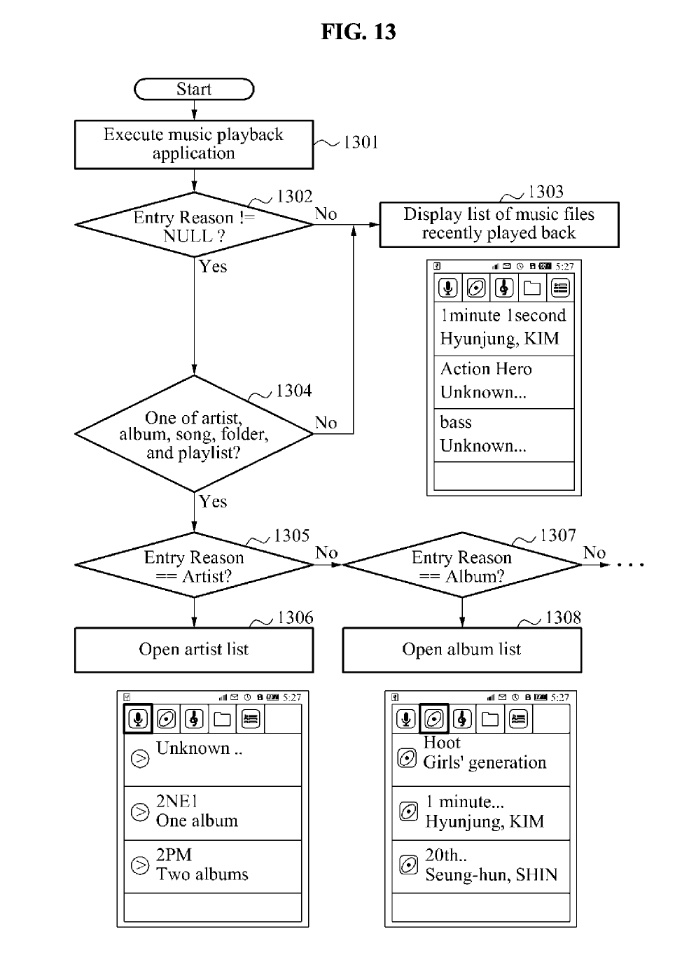

FIG. 13 is a flowchart of a method for selecting and driving execution of a music playback application according to an exemplary embodiment of the present invention.

In operation 1301, a communication terminal may execute a music playback application. In operation 1302, the music playback application may determine whether a voice command indicating music information is input into an entry reason determination. If the voice command is not input, in operation 1303, the music playback application may display, as a default screen, such as, a list of music files recently played.

If the voice command is input, in operation 1304, the music playback application may determine whether the entry reason is one of multiple categories of music information, for example, an artist, an album, a song, a folder, and a playlist. The multiple categories of music information may correspond to entry reasons of the music playback application. If the voice command is one of the categories of music information, the communication terminal proceeds to determine which categories of music information the voice command corresponds to. For example, in operation 1305, the music playback application may determine whether an artist is input as the entry reason. If the artist is input, in operation 1306, the music playback application may display an artist list. If the entry reason is not an artist, the method proceeds to operation 1307. In operation 1307, the music playback application may determine whether the entry reason is an album. If the album is input, in operation 1308, the music playback application may display an album list.

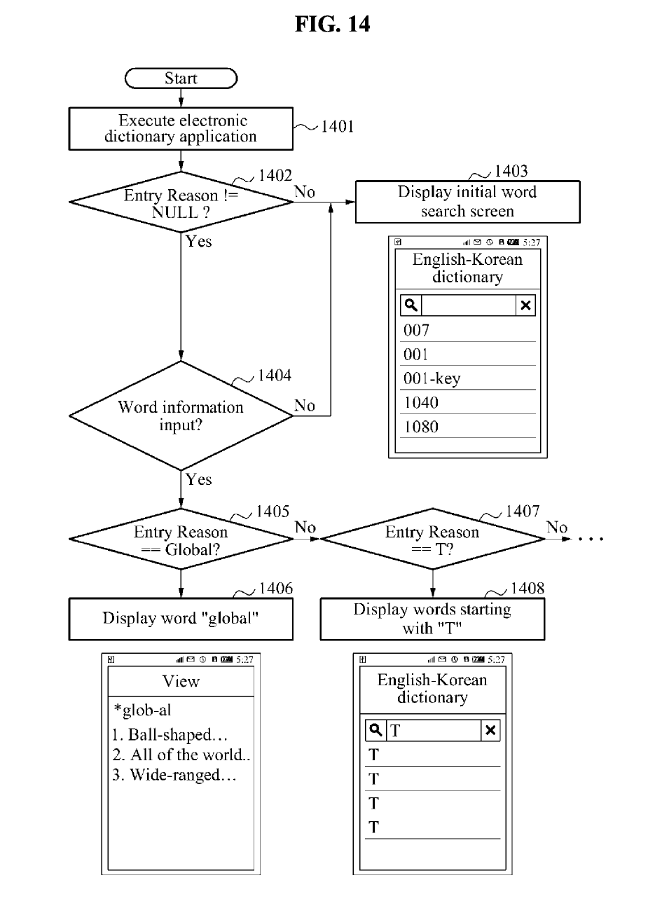

FIG. 14 is a flowchart of a method for selecting and driving execution of an electronic dictionary browser according to an exemplary embodiment of the present invention.

In operation 1401, a communication terminal may execute an electronic dictionary application. In operation 1402, the electronic dictionary application may determine whether a voice command indicating a word is input into an entry reason determination. If the voice command is not input, in operation 1403, the electronic dictionary application may display a default screen, such as, an initial word search screen.

If the voice command is input, in operation 1404, the electronic dictionary application may determine whether the entry reason is word information. The word information may correspond to entry reasons of the electronic dictionary application. If the voice command is word information, the communication terminal proceeds to determine which word information the voice command corresponds to. For example, in operation 1405, the electronic dictionary application may determine whether a word “global” is input as the entry reason. In operation 1406, if the word “global” is input, the electronic dictionary application may display word information associated with the word “global.” If the entry reason is not the word “global,” the method proceeds to operation 1407. In operation 1407, the electronic dictionary application may determine whether a word starting with “T” is input as the entry reason. If a word starting with “T” is input, in operation 1408, the electronic dictionary application may display word information associated with words starting with “T.”

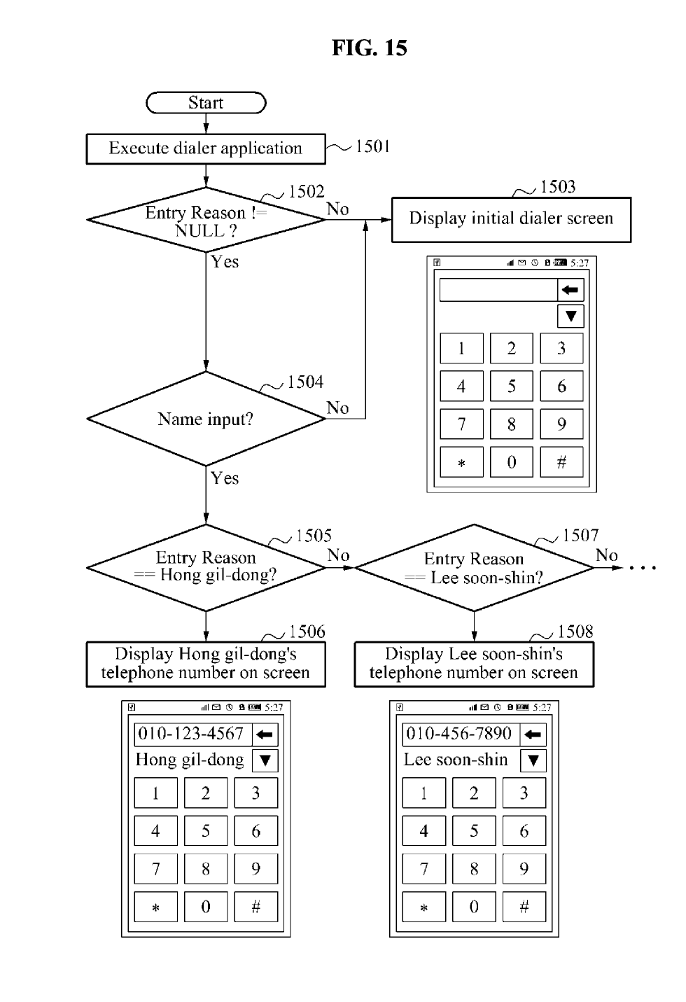

FIG. 15 is a flowchart of a method for selecting and driving execution of a dialer application according to an exemplary embodiment of the present invention.

In operation 1501, a communication terminal may execute a dialer application. In operation 1502, the dialer application may determine whether a voice command indicating a name of an address book is input into an entry reason determination. If the voice command is not input, in operation 1503, the dialer application may display an initial dialer screen as a default screen.

If the voice command is input, in operation 1504, the dialer application may determine whether the entry reason is the name of the address book. For example, in operation 1505, the dialer application may determine whether “Hong gil-dong” is input as the entry reason. If “Hong gil-dong” is input, in operation 1506, the dialer application may display a telephone number associated with “Hong gil-dong.” If the entry reason is not “Hong gil-dong” the method proceeds to operation 1507. In operation 1507, the dialer application may determine whether “Lee soon-shin” is input as the entry reason. In operation 1508, the dialer application may display a telephone number associated with “Lee soon-shin.”

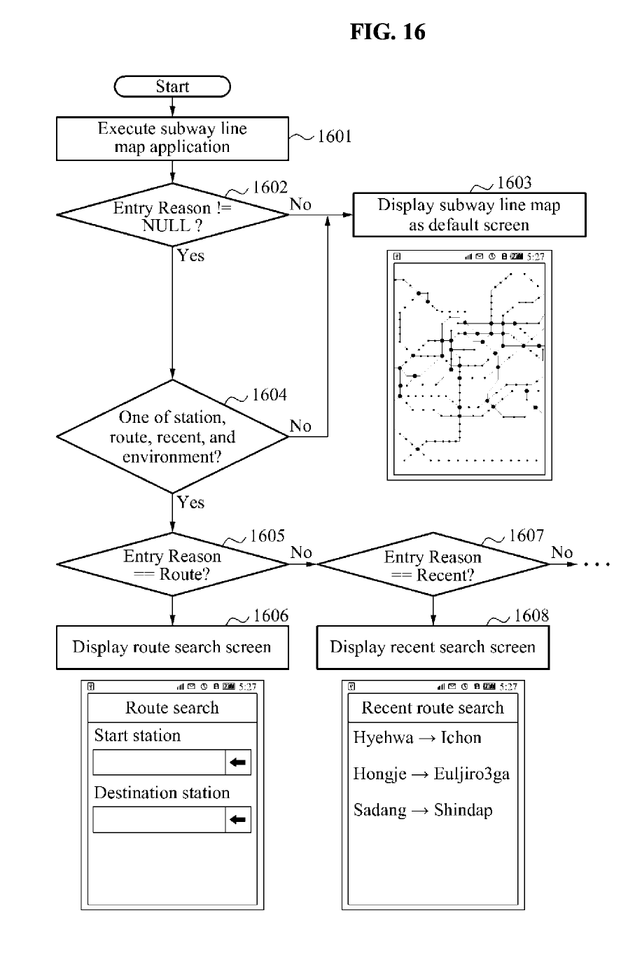

FIG. 16 is a flowchart of a method for selecting and driving execution of a subway line map application according to an exemplary embodiment of the present invention.

In operation 1601, a communication terminal may execute a subway line map application. In operation 1602, the subway line map application may determine whether a voice command indicating a subway line is input into an entry reason determination. If the voice command is not input, in operation 1603, the subway line map application may display default screen, for example, a subway line map.

If the voice command is input, in operation 1604, the subway line map application may determine whether the entry reason is subway line information, for example, a station, a route, recent, and environment. For example, in operation 1605, the subway line map application may determine whether a route is input as the entry reason. If the route is input, in operation 1606, the subway line map application may display a route search screen. If the entry reason is not a route the method proceeds to operation 1607. In operation 1607, the subway line map application may determine whether “recent” is input as the entry reason. If “recent” is input, the subway line map application may display a recent search screen in operation 1608.

The exemplary embodiments according to the present invention may be recorded in non-transitory computer-readable media including program instructions to implement various operations embodied by a computer. The non-transitory computer-readable media may also include, alone or in combination with the program instructions, data files, data structures, and the like. The non-transitory computer-readable media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, it may be possible to provide an application execution environment which may decrease a plurality of touch input operations to a one-time operation and thereby execute an execution screen selected by a user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for directly executing a function of an application in a terminal, the method comprising:
selecting an application to execute;
receiving a sound input;
analyzing the sound input to identify a voice input;
determining an entry reason from the voice input;
determining if the entry reason is a valid entry reason; and
if the entry reason is the valid entry reason, directly executing a function of the application corresponding to the entry reason and displaying the execution thereof.

2. The method of claim 1, wherein selecting an application to execute comprises:
selecting the application via a touch-down event,
wherein the voice input is received during a touch-down event.

3. The method of claim 1, wherein analyzing the voice input and determining an entry reason comprises:
filtering the sound input;
determining a voice input in the filtered sound input;
converting the voice input into analyzable voice data; and
performing syntax analysis of the analyzable voice data.

4. The method of claim 1, wherein the application is one of a browser application, a video playing application, a music playing application, an electronic dictionary application, a dialer application, and a map application.

5. The method of claim 1, wherein determining if the entry reason is a valid entry reason comprises determining if the entry reason matches a reference entry reason.

6. A voice input apparatus, comprising:
a display unit configured to display an icon of an application;
an input interface configured to receive a selection event on the icon;
a voice input unit configured to receive sound data, to extract voice data from the sound data, and to determine if the voice data is an entry reason; and
an execution manager configured to execute the application according to a touch-up event and the voice data if the voice data is the entry reason.

7. The apparatus of claim 6, wherein the display icon activates the voice input unit if the icon is selected.

8. The apparatus of claim 6, wherein the input interface determines if the selection event has moved locations and the display unit displays a speech bubble if a touch-down event is detected.

9. The apparatus of claim 8, wherein the voice input unit extracts voice data from the sound data comprises:
filtering the sound data;
determining a voice frequency in the filtered sound input;
converting the voice frequency into analyzable voice data; and
performing syntax analysis of the analyzable voice data.

10. The apparatus of claim 6, wherein the application is one of a browser application, a video playing application, a music playing application, an electronic dictionary application, a dialer application, and a map application.

11. The apparatus of claim 6, wherein the voice input unit is configured to determine if the voice data is the entry reason comprises determining if the entry reason matches a reference entry reason.

12. A method for executing an application in a terminal, comprising:
detecting a touch-down event on an icon of an application;
determining if sound data is received;
if sound data is received, determining if the sound data is a voice command;
determining if the voice command is an entry reason for the application; and
if the voice command is an entry reason executing the application and displaying an entry reason execution screen according to the voice command.

13. The method of claim 12, wherein determining if the sound data is voice command comprises:
filtering the sound data;
determining a voice data in the filtered sound data;
converting the voice data into analyzable voice data; and
performing syntax analysis of the analyzable voice data.

14. The method of claim 12, further comprising:
displaying a speech bubble image; and
receiving the sound data if the touch-down event is moved to the bubble image.

15. The method of claim 12, further comprising;
detecting a touch-up event and executing the application according to the touch-up event.

16. The method of claim 12, wherein the sound data is received during the touch-down event.

17. The method of claim 12, wherein the application is one of a browser application, a video playing application, a music playing application, an electronic dictionary application, a dialer application, and a map application.
